(19) United States
(12) Patent Application Publication
(10) Pub. No.: US 2004/0016137 A1
(43) Pub. Date: Jan. 29, 2004

(54) Electrolytic tilt sensor having a meniscus inhibitor

(76) Inventor: Barry E. Barsky, Huntingdon Valley, PA (US)

Correspondence Address: Gregory J. Lavorgna, Esq., Drinker Biddle & Reath LLP, One Logan Square, 18th and Cherry Streets, Philadelphia, PA, 19103-6996, US

(21) Appl. No.: 09/740,097

(22) Filed: Dec. 19, 2000

Related U.S. Application Data
(63) Continuation-in-part of application No. 09/544,533, filed on Apr. 6, 2000, now Pat. No. 6,249,984.

(51) Int. Cl. G01C 9/06

(52) U.S. Cl. 33/366.15

(57) ABSTRACT

A meniscus inhibitor for an electrolytic tilt sensor having a metallic containment envelope having at least two apertures formed therein and an interior chamber, an electrolytic solution partially filling the chamber, and at least two electrodes, each electrode having an electrolytically active portion located within the chamber and a lead portion extending to the exterior of the envelope through a corresponding one of the apertures. The meniscus inhibitor is located within the interior chamber and is a nonporous, chemically resistant, high dielectric material which surrounds the electrodes and is in contact with a peripheral wall of the interior chamber. Also disclosed is an electrolytic tilt sensor having improved linearity and response time, and which includes a metallic containment envelope defining a chamber and having a plurality of apertures therethrough; an electrolytic solution partially filling the chamber; a plurality of electrodes, each electrode extending through a corresponding one of the apertures and having an electrolytically active portion located within the chamber and spaced apart from an interior surface of the envelope and a lead portion extending to the exterior of the envelope, at least one of the electrodes being a sensing electrode and at least one electrode being a common electrode; and a meniscus inhibitor located within the interior chamber and being a nonporous, chemically resistant, high dielectric material surrounding the electrodes and in contact with a peripheral wall of the interior chamber.

### CROSS-REFERENCE TO RELATED APPLICATION

This is a continuation-in-part of co-pending application Ser. No. 09/544,533 filed Apr. 6, 2000, the disclosure of which is incorporated herein by reference.

### FIELD OF THE INVENTION

The present invention relates generally to electrochemical transducers and, more particularly, to electrolytic tilt sensors.

### BACKGROUND OF THE INVENTION

Electrolytic tilt sensors include devices that provide output signals proportional to the angle of tilt and/or the direction of tilt when included as part of an appropriate electrical circuit. Tilt sensors were originally developed for weapons delivery and aircraft navigation and are now used in applications such as oil drilling, construction laser systems, automotive wheel alignment, seismic and geophysical monitoring, virtual reality systems, and robotic manipulators.

Most conventional electrolytic tilt sensors generally comprise a housing, or envelope, made of a non-conductive material, such as glass. The envelope is partially filled with an electrolytic solution and encloses a plurality of electrodes, which are partially immersed in the electrolytic solution when the tilt sensor is in its upright (i.e., zero tilt or electrical null) position. One of the electrodes, typically a center electrode, is a common electrode, and the remaining electrodes are sensing electrodes, which are typically grouped in one or more pairs that define one or more distinct tilt axes in conjunction with the center common electrode.

As the tilt sensor is tilted with respect to the horizontal, each of the sensing electrodes becomes more or less immersed in the electrolytic solution while the surface of the solution remains level with reference to the horizontal. The increase or decrease in immersion results in a corresponding change in impedance between any one of the sensing electrodes and the common electrode. This impedance change is measured by an electrical circuit and correlated to a tilt angle and/or tilt direction, depending on the number of sensing electrodes and the type of electrical circuit being used.

Conventional tilt sensors exhibit the phenomenon of hysteresis when the tilt sensor is tilted with respect to the horizontal. Hysteresis is a measure of the time it takes for the electrolytic fluid to reach equilibrium with reference to the horizontal when the tilt sensor is moved to a new position. Hysteresis affects the reaction time in a tilt sensor, and can inhibit the response time of the device. It is believed that this phenomenon is due to the formation of a meniscus in the electrolyte where the electrolyte comes in contact with the sensor envelope. It is believed that the meniscus increases the time it takes for the electrolytic fluid to flow to a new equilibrium position when the sensor is moved, with a concomitant lag in response time of the sensor.

Formation of a meniscus in the electrolyte has been observed to cause a “snapping” action as the meniscus contacts each internal surface or member while the sensor is being tilted. This snapping action causes sudden and undesirable, and even unpredictable, changes in the electrodes' electrical output. The snapping action has also been observed to recur as the fluid contained in the meniscus drains into the envelope when the device reaches a steady-state position. These effects can be observed electronically.

There is a need for an electrochemical tilt sensor which does not exhibit a hysteresis effect or “snapping” action when moved from one position to another, and which exhibits a rapid response to changes in position. The present invention fills that need.

### SUMMARY OF THE INVENTION

The present invention broadly comprises a meniscus inhibitor for an electrolytic tilt sensor of the type that includes a metal containment envelope. The meniscus inhibitor is located within the containment envelope between the sensing electrodes and the side wall of the containment envelope. The meniscus inhibitor comprises a nonporous, chemically resistant, high dielectric material, such as, but not limited to, polypropylene or polyethylene. The meniscus inhibitor occupies at least a portion of the interior volume of the containment envelope where a meniscus would normally form, thus greatly reducing the fluid volume normally consumed by the meniscus.

In another aspect, the present invention comprises an electrolytic tilt sensor that includes a containment envelope defining a chamber, a meniscus inhibitor, a longitudinal axis, and a plurality of apertures located in the envelope and arranged around the longitudinal axis. The containment envelope includes a first metal member having an opening therein and a second metal member sealingly engaging the opening in the first member. A meniscus inhibitor in the form of a thin-walled tube of nonporous, chemically resistant, high dielectric material is located in contact with the interior wall of the chamber, and takes up a portion of the interior volume of the chamber. The interior volume remaining in the chamber is partially filled with an electrolytic solution. Electrodes in parallel relationship with the longitudinal axis are provided, each electrode having an electrolytically active portion located within the chamber and a lead portion extending to the exterior of the envelope through a separate one of the apertures. Each aperture has an insulator located therein between each respective electrode and the envelope.

The meniscus inhibitor of the present invention inhibits meniscus formation. The meniscus inhibitor also limits electric output effects of the meniscus phenomenon as well as limiting hysteresis due to fluid flow dynamics inside the containment assembly. The meniscus inhibitor occupies the volume where the electrolyte would exist inside the containment assembly in the meniscus inhibitor's absence. The meniscus inhibitor reduces the ability for the electrolyte fluid to form a meniscus and occupies the volume normally assumed by the meniscus. The meniscus inhibitor also reduces the drainage time of any meniscus that can form, reducing reaction time of the tilt sensor.

### BRIEF DESCRIPTION OF THE DRAWINGS

For the purposes of illustrating the invention, the drawings show a form of the invention that is presently preferred. However, it should be understood that this invention is not limited to the precise arrangements and instrumentalities shown in the drawings.

FIG. 1 is an exploded view of a tilt sensor including a meniscus inhibitor according to the invention, also showing the electrodes and end cap.

FIG. 2 is a cross-sectional view, in the upright position, of the tilt sensor illustrated in FIG. 1, shown with an electrolyte fluid therein.

FIG. 3 is a cross-sectional view, in the inverted position “null” position, of a tilt sensor containing an electrolyte fluid, without a meniscus inhibitor. FIG. 4 shows the tilt sensor of FIG. 3 after it has been inclined to an angle of 45 degrees, showing the formation of a meniscus. FIG. 5 shows the tilt sensor after it has been moved from the position shown in FIG. 4 to an inclination of less than 45 degrees, showing drainage of the fluid and the persistence of the meniscus. Taken together, FIGS. 3 through 5 illustrate the formation of the meniscus as the sensor is moved.

FIG. 6 is a cross-sectional view, in the inverted position “null” position, of a tilt sensor containing an electrolyte fluid, but including a meniscus inhibitor according to the invention. FIG. 7 shows the tilt sensor of FIG. 6 after it has been inclined to an angle of 45 degrees, and illustrated a greatly reduced meniscus. FIG. 8 shows the tilt sensor after it has been moved from the position shown in FIG. 7 to an inclination of less than 45 degrees, showing drainage of the fluid and the almost complete absence of a meniscus.

FIG. 9 illustrates the performance of an electrolytic tilt sensor without a meniscus inhibitor according to the invention.

FIGS. 10 and 11 illustrate the performance of electrolytic tilt sensors which have a meniscus inhibitor according to the invention.

### DETAILED DESCRIPTION OF THE DRAWINGS

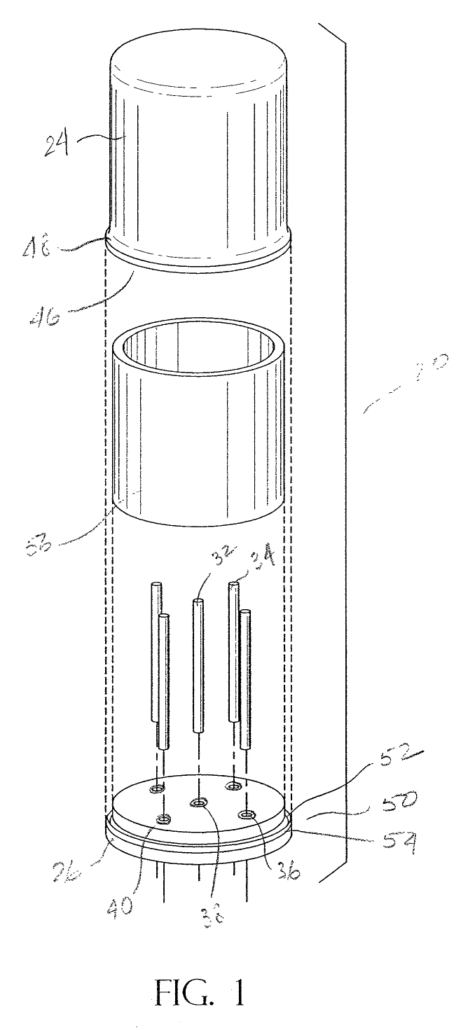

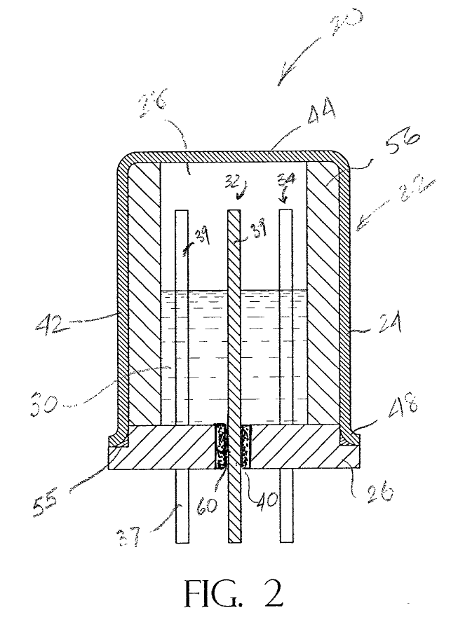

Referring to the drawings, wherein like numerals indicate like elements, FIGS. 1 and 2 illustrate an electrolytic tilt sensor according to the invention, designated generally by the numeral 20. The tilt sensor 20 comprises a containment assembly 22 having a generally cylindrical shape. The containment assembly 22 includes a metallic container 24 and a metal header 26. The metallic container 24 and header 26 define a chamber 28, which is partially filled with an electrolytic solution 30.

A plurality of conductors in the form of pins or wires 32, 34 extend from outside the containment assembly 22 into the chamber 28 through a plurality of apertures 36, 38 in the header 26. The portions of the conductors 32, 34 outside the containment assembly 22 define terminal portions 37 for connecting the tilt sensor to an appropriate electrical circuit. The portions of the conductors 32, 34 inside the containment assembly 22 define electrically conductive electrodes 39 that are subject to immersion in the contained electrolytic solution 30, as shown in FIG. 2. The conductors 32, 34 are electrically insulated from the header 26 by insulators 40, which also support the conductors 32, 34 in the apertures 36, 38.

The metallic container 24 has a side wall 42 and a top wall 44 attached to or integral with the upper end of the side wall 42. In the illustrated and preferred embodiment, the metallic container 24 is a commercially available transistor cap, such as those manufactured by Richards Metal Products, Inc. of Wolcott, Conn. Whether or not a commercially available container is used, it is preferred that the side wall forms a cylindrical tube and the top wall is planar and formed integral with the side wall. However, the side wall may be another shape, such as rectangular or other axially symmetric shape, and the top wall may have another shape such as arcuate, or the like. The lower end of the side wall 42 defines an opening 46 in the metallic container 24 and terminates at an outwardly-turned lip or flange 48. Although it is preferred to provide a flange to facilitate attaching the header to the cap, it need not be provided. In an alternative embodiment, the outer surfaces of the containment assembly may include a non-conductive outer layer such as a plastic shell, a protective polymer coating, or the like.

The header 26 comprises a planar disc 50 having a flange 52 around its outer periphery. In the illustrated and preferred embodiment, the header 24 is one that is commercially available, such as those manufactured for the transistor industry. Other headers, however, may be used. The outer periphery of the disc 50 engages the inner periphery of the side wall 42 and the upper surface of the flange 52 engages the lower surface of the flange 48.

A hermetic, continuous seal is provided at the interface between the two flanges 48, 52, preferably by welding. The preferred method of welding the flanges 48, 52 to one another is to use an instantaneous method, which utilizes an annular welding ridge 54 on the flange 52. During welding, the welding ridge 54 concentrates the welding current and is thereby melted to form a weld bead 55 that joins the header 26 to the metallic container 24 and hermetically seals the containment assembly 22.

As illustrated, the header 26 includes five apertures 36, 38. Four of the apertures 36, for the sensing conductors 34, are arranged in quadrature around the center of the header 26. The fifth aperture 38, for the center common conductor 32, is located at the center of the header 26. Although five apertures are indicated for accommodating five conductors, more or fewer apertures may be provided depending on the number of pin-type conductors used. The apertures may also be located in the upper wall of the container instead of the header. However, the header would still be attached to the container as described above, preferably by welding.

The metallic container 24 and the header 26 are preferably made of one or more nonprecious metals, such as Grade A nickel, cold-rolled steel plated with nickel, KOVAR® alloy, Alloy 52, or the like (KOVAR® is a registered trademark of Carpenter Technologies Corporation, Reading, Pa.). The metal or metallic alloy is selected to be noncorroding in the presence of the electrolytic solution used. Alternatively to nonprecious metals, the container 24 and header 26 may be made of a precious metal. In the embodiment illustrated in the drawings and described herein, it is critical that the respective coefficients of thermal expansion of the materials selected for the header 26, the conductors 32, 34, and the insulators 40 all be compatible in order to keep the chamber hermetically sealed as ambient temperature changes. Also important to maintaining the hermetic seal is the glass-to-metal seal bond between the header 26 and the insulators 40.

The pin-type conductors 32, 34 include a center common conductor 32 and two pairs of spaced apart sensing conductors 34. The conductors 34 in each sensing conductor pair are located at diametrically opposite locations relative to the center conductor 32 and define a distinct tilt axis with the common conductor 32. The number and arrangement of the conductors are design variables that are known to, and would be selected by, those skilled in the art. For example, the center common conductor 32 may be eliminated, in which case the containment assembly would function as a common conductor.

The sensing conductors 34 are preferably arranged in quadrature about the center axis of the chamber, and the common conductor 32 is preferably located at the center axis. Being located in quadrature, the two pairs of diametrically opposed conductors define two orthogonal tilt axes, for example, Cartesian X and Y axes. In this configuration, the output voltages of the sensing conductors are measured and correlated to one another to provide the angle of tilt regardless of direction. In addition, if a direction reference is established, the output voltages may be further used to determine the direction of tilt.

The preferred conductors are the pin-type conductors shown. However, other types of conductors may be used. Moreover, the electrolytically active portions may be other than pin shaped to suit a particular application of the tilt sensor 20. For example, the electrolytically active portions may be arcuate, coiled, meandering, or the like. Also, the terminal portions may comprise strips, braids, foils, or the like. The presently-preferred conductor materials are KOVAR® alloy and Alloy 52. These alloys are preferred because their coefficients of expansion are compatible with the coefficient of expansion of the material preferred for the insulators. However, other nonprecious metals, alloys and precious metals may be used.

In the preferred embodiment, the insulators 40 are glass beads, such as Corning 7052 glass available from Corning Incorporated, Corning, N.Y. Each glass bead has a center bore 60 for receiving a corresponding one of the conductors 32, 34. Other insulator materials, such as porcelain, ceramic, or the like, may be used. Regardless of which material is selected, the aforementioned concerns regarding the glass-to-metal seals and the compatibility of coefficients of expansion of the various components must be addressed.

The electrolytic solution 30 may be selected from a group comprising nonaqueous, semi-aqueous and noncorrosive solutions. Preferably, the electrolytic solution is a non-halogenated solution, which generally has a non-deleterious effect on the nonprecious metal components of the preferred embodiment. Halogenated solutions should be used only with precious metal components.

In addition to the elements just described, tilt sensor 20 includes a meniscus inhibitor 56. Meniscus inhibitor 56 is preferably in the form of a thin-walled hollow cylinder or tube, the outer diameter of which is approximately equal to or just slightly greater than the internal diameter of the metallic container 24, so that the meniscus inhibitor 56 fits snugly against the inner wall of the metallic container. The wall thickness of the meniscus inhibitor 56, which defines its internal diameter, is not crucial, as long as the meniscus inhibitor leaves sufficient room within chamber 28 for the conductors 32, 34 and the electrolytic solution 30. The length of the meniscus inhibitor 56 should be approximately equal to the distance between the disk 50 of header 26 and the inner surface of top wall 44 of metallic container 24. As one example, if the metallic container comprises the standard TO-5 package, the outer diameter of the meniscus inhibitor 56 would be 0.302 inch, and the wall thickness would be approximately 0.030 to 0.035 inch. The meniscus inhibitor in this example would have a length of approximately 0.348 inch. As those skilled in the art will understand, other dimensions can be used, as would be appropriate for a given configuration and dimensions of the metallic container 24.

Preferably, although not necessarily, there should be an approximate clearance of 0.010 inch between the meniscus inhibitor and the nearest conductor 34.

As noted above, the meniscus inhibitor should be a nonporous, chemically resistant, high dielectric material. Preferred, but by no means the only, materials are polymeric materials such as polypropylene or polyethylene.

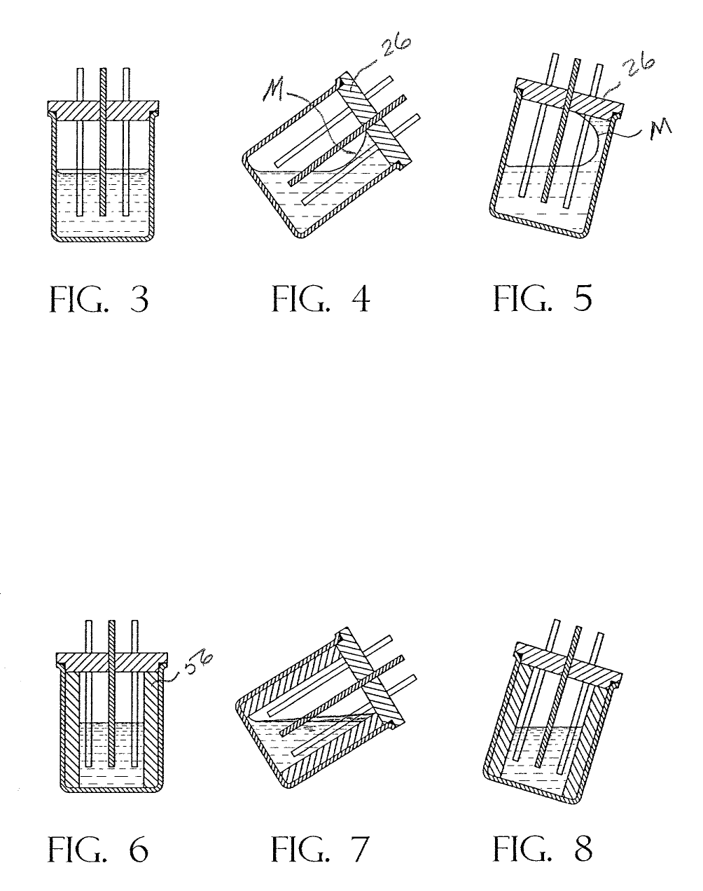

Referring now to FIGS. 3 through 5, the behavior of an electrolytic tilt sensor without a meniscus inhibitor is illustrated. In FIG. 3, the electrolytic sensor without a meniscus inhibitor is illustrated in an inverted position in which its longitudinal axis is substantially vertical. This position is referred to as the “null” position. FIG. 4 shows the electrolytic tilt sensor without a meniscus inhibitor inclined at an angle of 45° (i.e., the longitudinal axis of the sensor is at 45° to the vertical). In the position shown in FIG. 4, a meniscus M forms adjacent the header 26. When the sensor is thereafter moved to a different position, such as the intermediate position shown in FIG. 5, the meniscus M persists, and delays the drainage of the electrolytic fluid to a new equilibrium position. The delay in drainage of the fluid manifests itself in increased response time of the sensor.

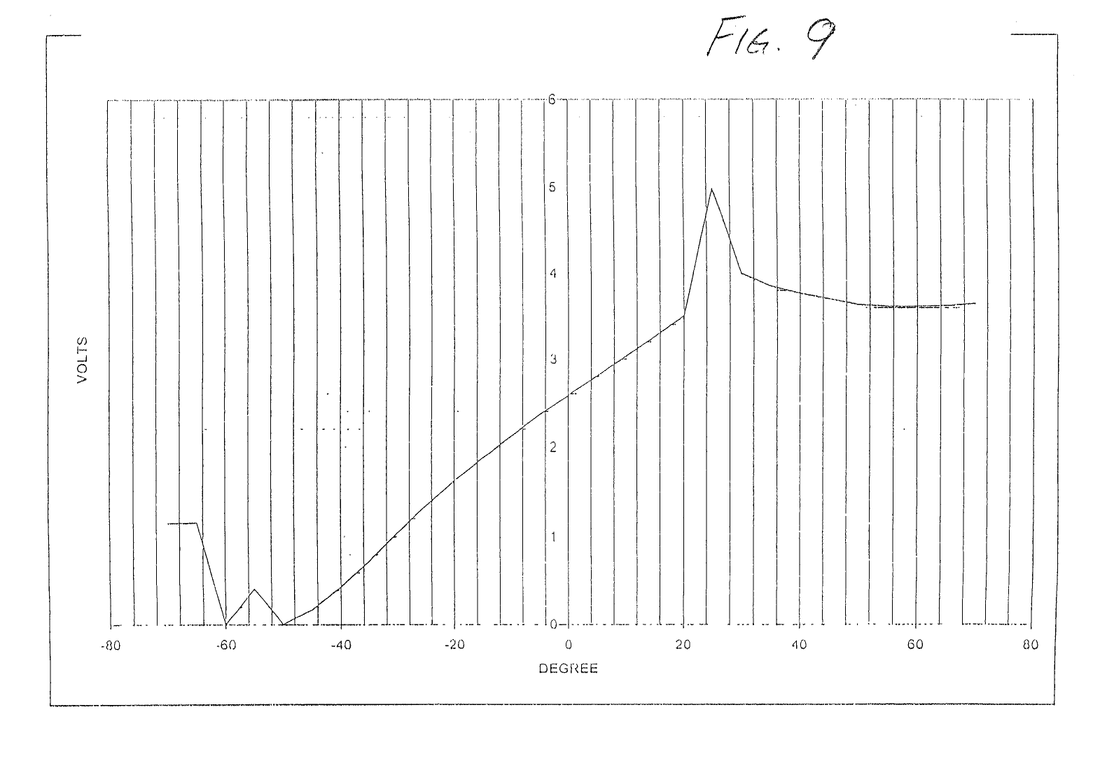

FIGS. 6 through 8 illustrate the behavior of the same electrolytic tilt sensor, but with the meniscus inhibitor 56 in place. In FIG. 6, the electrolytic sensor with the meniscus inhibitor 56 is illustrated in the “null” position. FIG. 7 shows the electrolytic tilt sensor with the meniscus inhibitor 56 inclined at an angle of 45°. It can be seen that, in contrast to the tilt sensor shown in FIG. 4, in the tilt sensor with meniscus inhibitor 56 shown in FIG. 7, no meniscus forms. The meniscus inhibitor assumes the volumetric space the electrolyte solution 30 would fill between the interior side walls 42 and the sensing conductors 34, thus preventing formation of a meniscus. When the sensor is thereafter moved to a different position, such as the intermediate position shown in FIG. 8, there is no meniscus to delay the drainage of the electrolytic fluid to a new equilibrium position. The electrolytic fluid is therefore able to reach equilibrium virtually instantaneously, with virtually no delay in sensor response time.

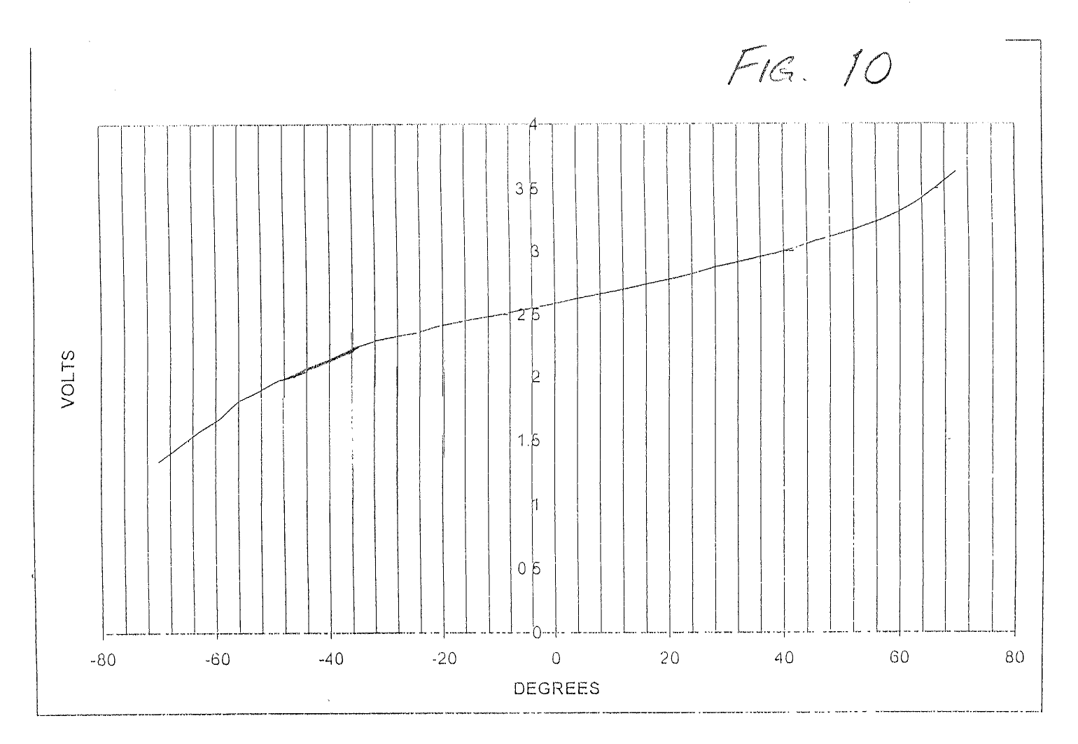

The behavior of an electrolytic tilt sensor without a meniscus inhibitor compared to the behavior of an electrolytic tilt sensor with a meniscus inhibitor can be measured and graphed, as shown in FIGS. 9 through 11. FIG. 9 illustrates the behavior of an electrolytic tilt sensor without a meniscus inhibitor, designed to function within a maximum variable range of ±70°. FIG. 9 represents output voltage as a function of the angular orientation of the sensor, from 70° to one side of the null position to 70° to the other side. As the graph indicates, the viable range, in which the output voltage varies linearly with angular orientation, is severely restricted, and ranges from −50° to +20°. The graph also indicates regions where the “snapping” effect occurs. This is believed to be the result of the electrolytic fluid making contact with specific internal features of the sensor, and may be caused by rupture of the surface tension of the fluid upon penetration of the wire electrodes and the fluid displacing air at the right angle convergences of the welded joint between the metallic container 24 and the header 26. The upper right quadrant of the graph also exhibits a horizontal curvilinear region, which is believed to represent drainage of the electrolytic fluid from the weld convergence. This phenomenon is interpreted as a hysteresis effect occurring when the sensor returns to the null position from ±45° or greater.

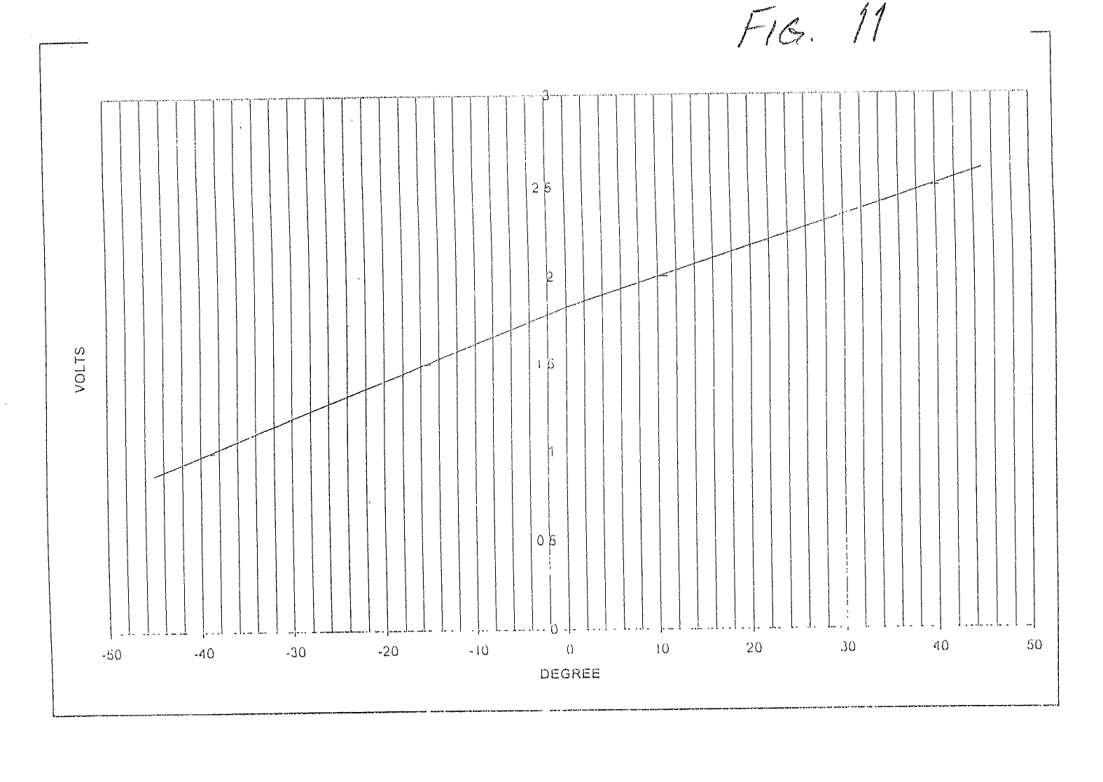

FIG. 10 illustrates the behavior of an electrolytic tilt sensor with a meniscus inhibitor according to the invention, also designed to function within a maximum variable range of ±70°. As the graph of FIG. 10 illustrates, the sensor exhibits good linearity over the full design range of ±70°, and exhibits no hysteresis effects that would limit response. FIG. 11 illustrates the behavior of another electrolytic tilt sensor with a meniscus inhibitor according to the invention, with a shorter metallic container designed to function within a maximum variable range of ±45°. As the graph of FIG. 11 shows, the sensor with meniscus inhibitor exhibits excellent linearity across the entire design range.

Although the invention has been described and illustrated with respect to an exemplary embodiment thereof, it should be understood by those skilled in the art that the foregoing and various other changes, omissions, and additions may be made therein and thereto, without parting from the spirit and scope of the present invention.

1. In an electrolytic tilt sensor comprising a metallic containment envelope having at least two apertures formed therein and an interior chamber, an electrolytic solution partially filling the chamber, and at least two electrodes electrically isolated from the chamber, each electrode having an electrolytically active portion located within the chamber and a lead portion extending to the exterior of the envelope through a corresponding one of the apertures, a meniscus inhibitor located within the interior chamber and comprising a nonporous, chemically resistant, high dielectric material surrounding the electrodes and in contact with a peripheral wall of the interior chamber.

2. The meniscus inhibitor of claim 1, wherein the material is in the form of a hollow cylinder open at each end.

3. The meniscus inhibitor of claim 2, wherein the cylinder has a preselected outer diameter and a preselected inner diameter to define a preselected wall thickness and occupies at least a portion of the interior volume of the containment envelope where a meniscus would normally form for reducing fluid volume normally consumed by the meniscus.

4. The meniscus inhibitor of claim 1, wherein the material is a polymeric material.

5. The meniscus inhibitor of claim 4, wherein the polymeric material is selected from the group comprising polypropylene and polyethylene.

6. An electrolytic tilt sensor having improved linearity and response time, comprising:
a metallic containment envelope defining a chamber and having a plurality of apertures therethrough;
an electrolytic solution partially filling the chamber;
a plurality of electrodes, each electrode extending through a corresponding one of the apertures and having an electrolytically active portion located within the chamber and spaced apart from an interior surface of the envelope and a lead portion extending to the exterior of the envelope, at least one of the electrodes being a sensing electrode and at least one electrode being a common electrode; and
a meniscus inhibitor located within the interior chamber and comprising a nonporous, chemically resistant, high dielectric material surrounding the electrodes and in contact with a peripheral wall of the interior chamber.

7. The electrolytic tilt sensor according to claim 6, wherein the material is in the form of a hollow cylinder open at each end, the cylinder having a preselected outer diameter and a preselected inner diameter to define a preselected wall thickness, the cylinder occupying at least a portion of the interior volume of the containment envelope where a meniscus would normally form for reducing fluid volume normally consumed by the meniscus.

8. The electrolytic tilt sensor according to claim 6, wherein the material is selected from the group comprising polypropylene and polyethylene.

9. The electrolytic tilt sensor according to claim 7, wherein the material is selected from the group comprising polypropylene and polyethylene.

10. An electrolytic tilt sensor having improved linearity and response time, comprising:
a metallic containment envelope defining a chamber and having a plurality of apertures therethrough;
an electrolytic solution partially filling the chamber;
a plurality of electrodes, each electrode being electrically isolated from the chamber and extending through a corresponding one of the apertures, each electrode further having an electrolytically active portion located within the chamber and spaced apart from an interior surface of the envelope and a lead portion extending to the exterior of the envelope, at least one of the electrodes being a sensing electrode and at least one electrode being a common electrode; and
a meniscus inhibitor located within the interior chamber and comprising a hollow cylinder open at each end and surrounding the electrodes and in contact with a peripheral wall of the interior chamber, the cylinder being a nonporous, chemically resistant, high dielectric material and having a preselected outer diameter and a preselected inner diameter to define a preselected wall thickness, the cylinder occupying at least a portion of the interior volume of the containment envelope where a meniscus would normally form for reducing fluid volume normally consumed by the meniscus.

11. The electrolytic tilt sensor according to claim 10, wherein the material is selected from the group comprising polypropylene and polyethylene.
